(19) United States
(12) Patent Application Publication
(10) Pub. No.: US 2017/0153682 A1
(43) Pub. Date: Jun. 1, 2017

(54) TRANSIENT STABILITY SIMULATION AND OPERATION OF POWER SYSTEMS

(71) Applicant: University of Tennessee Research Foundation, Knoxville, TN (US)

(72) Inventors: Nan Duan, Knoxville, TN (US); Kai Sun, Knoxville, TN (US)

(21) Appl. No.: 14/956,076

(22) Filed: Dec. 1, 2015

(51) Int. Cl. G06F 1/28; G06F 17/50

(52) U.S. Cl. CPC G06F 1/28; G06F 17/5009

(57) ABSTRACT

Systems and methods for simulating and operating a power system following a contingency are provided. Semi-analytic solutions (SASs) for the power system state variables may be derived offline for a plurality of contingencies. Following a contingency, the SASs may be evaluated online, faster than real time, to study transient stability of the power system under a plurality of remedial scenarios. The stability of the power system may then be maintained by controlling the power system based on the most effective of the plurality of remedial scenarios.

### STATEMENT REGARDING FEDERALLY SPONSORED RESEARCH OR DEVELOPMENT

This invention was made with government support under a grant from the National Science Foundation, Award No. EEC-1041877. The U.S. Government has certain rights in this invention.

### BACKGROUND

The present disclosure generally relates to power systems, and simulation and operation of power systems.

Power system simulation finds application in operations of electrical power systems, commonly referred to as power grids. Operators of power grids run simulations to plan and schedule generation, transmission, and distribution of electrical power in a safe and reliable manner. Moreover, the operators use simulations to study the stability of their systems after clearing major disturbances, also known as contingencies, such as loss of a generator unit or a transmission line. Following such contingencies, generators, which are synchronous machines, experience deviations or transients from a common synchronous frequency (e.g., 60 Hz in the United States). Transient stability simulations allow operators to study whether or not the generators are able to return to the synchronous frequency after clearing a contingency (e.g., by isolating the lost generator or transmission line).

A power system's dynamic performance may be modeled from a set of nonlinear differential-algebraic equations (DAEs), involving a plurality of state variables that collectively represent the power system's state in time. In theory, there is no analytic or closed-form solution for the power system's state that is accurate over a typical simulation time period. Therefore, the DAEs are solved using time-domain simulations with numerical integration approaches that may include explicit methods (e.g., Euler and Runge-Kutta) or implicit methods (e.g., Trapezoidal and Backward Euler). For these simulations to be accurate, small time steps are used for iterative computations in order to give a convergent trajectory of the power system's state. For large-scale interconnected power grids, such simulations thus are often time-consuming and are usually run offline for hypothetical contingencies. As best industry practices, some operators simulate thousands of predefined contingencies every five to fifteen minutes in order to be prepared to remediate one these contingencies if it were to occur in the next five to fifteen minutes.

However, lengthy numerical integrations prohibit running transient stability simulations as soon as contingencies are cleared to test several candidate remedial actions such that operators can take the most effective remedial action to maintain stability of the power system. While parallelization using supercomputers with high-performance computing (HPC) clusters may speed up existing numerical integration methods, there is a limit to the reduction in simulation time that may be achieved because the fundamental mechanism of numerical integration does not lend itself well to parallel computing.

Therefore, the inventors recognized a need in the art for a transient simulation of power systems that is accurate over a prescribed simulation time period, that may be adapted to parallel computing, and that may be run in real time or faster than real time.

### BRIEF DESCRIPTION OF THE DRAWINGS

FIG. 1 illustrates a method of simulating a transient stability of a power system according to an embodiment of the present disclosure.

FIG. 2 is a plot of semi-analytic solutions (SASs) and a numerical solution according to an embodiment of the present disclosure.

FIGS. 3A and 3B are plots of SASs and numerical solutions for different initial conditions according to an embodiment of the present disclosure.

FIG. 4 illustrates a method of determining a maximum duration, according to an embodiment of the present disclosure.

FIG. 5 illustrates the IEEE 10-generator, 39-bus power system.

FIG. 6 is a plot of trajectories for state variables according to an embodiment of the present disclosure.

FIG. 7 is a plot of trajectories for state variables according to an embodiment of the present disclosure.

FIG. 8 is a plot of an SAS, terms of the SAS, and a numerical solution according to an embodiment of the present disclosure.

FIG. 9 illustrates a method of determining a maximum threshold and an associated divergence indicator according to an embodiment of the present disclosure.

FIGS. 10A and 10B illustrate an exemplary application of the method in FIG. 9 to a power system under two different contingencies according to an embodiment of the present disclosure.

FIG. 11 is a plot of trajectories for state variables according to an embodiment of the present disclosure.

FIG. 12 illustrates variations in adaptive time window durations according to an embodiment of the present disclosure.

FIG. 13 illustrates a parallel computation of an SAS-based simulation of a power system according to an embodiment of the present disclosure.

FIG. 14 illustrates an exemplary application of an SAS-based simulation to a power system according to an embodiment of the present disclosure.

### DETAILED DESCRIPTION

Embodiments of the present disclosure provide systems and methods for simulating and operating a power system following a contingency. Semi-analytic solutions (SASs) for the power system state variables may be derived offline for a plurality of contingencies. Following a contingency, the SASs may be evaluated online, faster than real time, to study transient stability of the power system under a plurality of remedial scenarios. The stability of the power system may then be maintained by controlling the power system based on the most effective of the plurality of remedial scenarios.

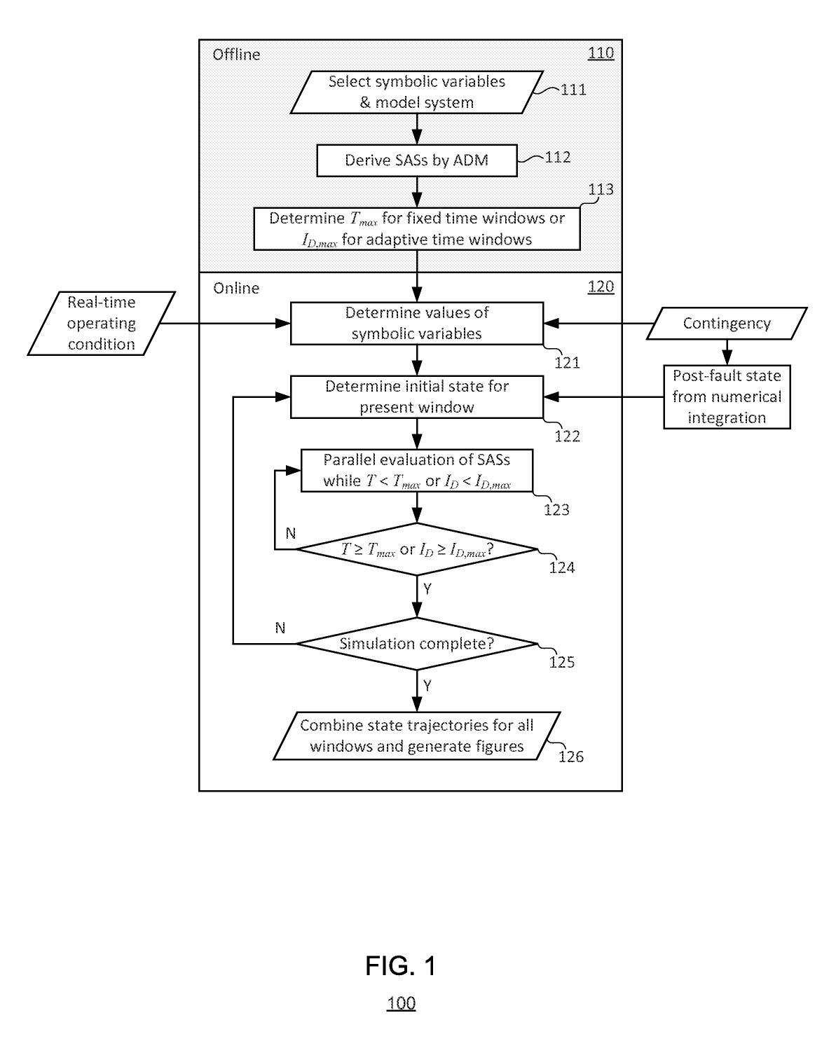

FIG. 1 illustrates a method 100 of simulating a transient stability of a power system according to an embodiment of the present disclosure. The method 100 includes an offline stage 110 to derive a plurality of SASs for state variables of the power system, and an online stage 120 to evaluate, after clearance of a contingency, the SASs over a simulation time period. Each SAS is an analytic or closed-form solution for a state variable of the power system. Given that each SAS is accurate over a short period of time, the SAS may be evaluated during the online stage 120 over a plurality of consecutive time windows making up the simulation time period. To maintain accuracy of the SAS during each time window, the method 100 determines during the offline stage 110 either a maximum duration for every time window or a maximum threshold that allows the durations of the time windows to adaptively vary when the SAS is evaluated during the online stage 120.

During the offline stage 110, at step 111, the method 100 comprises selecting a plurality of symbolic variables to model the power system. The method 100 may employ one of two approaches to model the power system. In the first approach, the method 100 may assume a specific post-contingency system topology (i.e., a constant system admittance matrix) for the power system, but may relax the system operating condition (e.g., generator outputs and load impedances) such that one SAS may simulate multiple loading conditions. In the second approach, the method 100 may further relax selected elements in the admittance matrix to enable one SAS to simulate multiple contingencies. Other symbolic variables may also be added as undetermined parameters, but, the more symbolic variables, the more complex is the expression of an SAS.

At step 112, assuming a constant impedance load at each bus of the power system, the method 100 applies a series expansion known as the Adomian Decomposition Method (ADM) to the power system model of step 111 to derive an SAS for each state variable modeled in step 111. Each SAS is a summation of finite number of terms out of an infinite number of terms from the ADM. Application of the ADM to an exemplary power system will be described below.

As discussed, an SAS is accurate over a short period of time. Therefore, at step 113 of the offline stage 110, the method 100 determines: (i) for SASs to be evaluated using fixed time windows (i.e., time windows of fixed duration), a maximum duration Tₘₐₓ during which state trajectories of the SASs are accurate, or (ii) for the SASs to be evaluated using adaptive time windows (i.e., time windows of variable durations), a maximum threshold I_{D,max} for a divergence indicator I_{D}. The divergence indicator I_{D} may be an absolute value of one of the ADM terms included in one of the analytic expressions of the SASs. Methods for determining a maximum duration Tₘₐₓ and a maximum threshold I_{D,max} will be described below.

The offline stage 110 may be performed in advance (e.g., hours, days, months, etc., in advance), independently of the online stage 120. The offline stage 110 may be rerun whenever needed—for example, when changes and/or upgrades are made to the power system. At the end of the offline stage 110, the SASs and the maximum duration Tₘₐₓ and/or the maximum threshold I_{D,max} may be stored in one or more repositories (e.g., databases), to be invoked when needed by the online stage 120.

Following clearance of a contingency (e.g., by isolating a fault at a generator, a transmission line, etc.), the online stage 120 begins at step 121, where the SASs and the duration Tₘₐₓ and/or the threshold I_{D,max} from the offline stage 110 are invoked. Values are determined for the symbolic variables selected at step 111, based on the contingency and a real-time operating condition of the power system. The real-time operating condition may be known from one or more monitoring systems (e.g., a supervisory control and data acquisition (SCADA) system) that are typically employed by power system operators.

At step 122, for the first time window of the simulation time period, a post-contingency state of the system may be used as an initial state (i.e., initial conditions to the state variables associated with the SASs). The post-contingency state may be provided by a numerical integration for the fault-on period until the fault is cleared. The numerical integration may be part of or separate from the method 100. Further at step 122, for every subsequent time window, the ending state of preceding window may be used as the initial state.

At step 123, using the values for the symbolic variables from step 121 and the initial state corresponding to the time window from step 122, the method 100 evaluates the SASs while: (i) for time windows of fixed intervals, an elapsed evaluation time T is less than the maximum duration Tₘₐₓ or (ii) for time windows of adaptive intervals, the absolute value of the divergence indicator I_{D} is less than the threshold I_{D,max}. Given that the SASs are independent expressions, they may be evaluated simultaneously on parallel computers, as will be described below.

At step 124, if either (i) T≧Tₘₐₓ or (ii) I_{D}≦I_{D,max}, the evaluation of the SASs for the present time window is considered complete and the method 100 proceeds to step 125. Otherwise, the method 100 remains at step 123 and the evaluation of the SASs continues. At step 125, if the cumulative duration of all the time windows is equal to or greater than the desired simulation time, the simulation is considered complete and the method 100 moves to step 126. Otherwise, the method 100 repeats steps 122-124 to evaluate the SASs over a subsequent time window. At step 126, state trajectories generated in each time window are combined such that graphical plots of one or more of the state trajectories may be provided over the simulation time period.

In the method 100, a power system is modeled at step 111 of the offline stage 110. A power system may include a plurality of generators and a plurality loads, interconnected by a plurality of transmission lines coupled at a plurality of buses. The generators are generally synchronous machines, which, under stable conditions, run at a common synchronous frequency (e.g., 60 Hz in the United States). The power system may further include devices such as transformers to step up or down voltages, tap changers, reactive power compensators, etc. The dynamic performance of such a power system may be modeled as a set of DAEs given by differential equations (1) and algebraic equations (2), where a state vector x may include M state variables of the power system (e.g., rotor angle and speed for each generator in the system) as in equation (3); a vector y may represent non-state variables (e.g., bus voltages), which may not completely depend on the state variables; a vector function g may represent dynamic devices (e.g., generators, exciters, and governors) in the power system; and, a vector function h may represent devices whose dynamics may be ignored. Accordingly, at step 111, the method 100 comprises selecting the symbolic variables to model the power system as in equation (1).

$$\begin{matrix}\frac{d x}{d t} = g ( x , y ) & ( 1 ) \\ 0 = h ( x , y ) & ( 2 ) \\ x ( t ) = \begin{matrix}[ {x}_{1} ( t ) & {x}_{2} ( t ) & … & {{x}_{M} ( t ) ]}^{T}\end{matrix} & ( 3 )\end{matrix}$$

In some cases, for example, when all branches and loads may be modeled as impedances during a simulation window, the vector y may explicitly be represented as a vector function of the state vector x in the algebraic equations (2). In such cases, the non-state variables represented by the vector y may be substituted into the differential equations (1), resulting in another set of differential equations (4), in which a vector function f may be represented by equation (5).

$$\begin{matrix}\frac{d x}{d t} = f ( x ) & ( 4 ) \\ f ( \cdot ) = \begin{matrix}[ {f}_{1} ( \cdot ) & {f}_{2} ( \cdot ) & … & {{f}_{M} ( \cdot ) ]}^{T}\end{matrix} & ( 5 )\end{matrix}$$

In theory, the set of differential equations (4) does not have an analytic or closed-form solution x(t) that is accurate over a typical simulation time period (e.g., 30 seconds or more). Thus, a numerical solution is typically obtained by running a simulation to solve an initial value problem (IVP). That is, given the set of different equations (4) and initial conditions for the M state variables, the simulation may carry out iterative computations at small time steps (e.g., 1 millisecond) to provide a convergent trajectory of the state vector x over the simulation time period.

However, according to an embodiment of the present disclosure, an approximate analytic solution—a semi-analytic solution (SAS)—, which is accurate for a short period of time (e.g., less than one second), may be derived offline for the state vector x (e.g., at step 112 of the method 100). The SAS may be defined by a sum of a finite number of terms out of an infinite number terms that may be derived from a series expansion known as the Adomian Decomposition Method (ADM).

The ADM starts by applying Laplace transform [symbol] [·] to transform the differential equations (4) into an algebraic equation (6) about the complex frequency s, where x(0) represents initial conditions for the state variables of the system.

$$[ x ] = \frac{x ( 0 )}{s} + \frac{ [ f ( x ) ]}{s} \qquad ( 6 )$$

With the assumption that the state vector x may be decomposed as a summation of infinite terms as in equation (7), the i^{th} element of the vector function f may be decomposed as a summation of infinite Adomian polynomials A_{i,n} as in equation (8). The Adomian polynomials are given by equation (9), wherein λ is called a grouping factor.

$$\begin{matrix}x ( t ) = {\sum }_{n = 0}^{∞} {x}_{n} ( t ) & ( 7 ) \\ \begin{matrix}{f}_{i} ( x ) = {\sum }_{n = 0}^{∞} {A}_{i , n} ( {x}_{0 ,} {x}_{1 , ⋯ ,} {x}_{n} ) , & i = 1 ⋯ M\end{matrix} & ( 8 ) \\ {A}_{i , n} = \frac{1}{n !} [ \frac{{\partial }^{n}}{\partial {λ}^{n}} {f}_{i} ( {\sum }_{i = 0}^{n} {x}_{i} {λ}^{i} ) ] {\vert}_{λ = 0} & ( 9 )\end{matrix}$$

By matching terms of x(t) and f(·) with the same index n, recursive formulas (10) and (11) may be derived for [symbol] [xₙ] (n≧0), where Aₙ=[A_{1,n}, . . . , A_{M,n}]^{T}.

[symbol]

[x₀]=x(0)/s (10)

[symbol]

[xₙ₊₁]= [symbol] [Aₙ]/s n≧0 (11)

Inverse Laplace transform [symbol] ⁻¹[·] may then be applied to both sides of the formulas (10) and (11) to obtain xₙ(t) for any n. An SAS for the system of equation (4) may then be defined as the sum of first N terms of xₙ(t) as given by equation (12).

$${x}^{SAS} ( t ) = {\sum }_{n = 0}^{N - 1} {x}_{n} ( t ) \qquad ( 12 )$$

To put equations (1)-(12) into context, consider a K-machine power system (i.e., a power system that includes K synchronous machines). Each synchronous machine k—where k={1, 2, . . . , K}—may be represented as a fourth-order two-axis model as in differential equations (13), and all the machines are coupled through nonlinear algebraic equations (14). Equations (13) and (14) are in the form of equations (1) and (2), respectively.

$$\begin{matrix}\{ \begin{matrix}{\dot{δ}}_{k} = {ω}_{k} - {ω}_{R} \\ {\dot{ω}}_{k} = \frac{{ω}_{R}}{2 {H}_{k}} ( {P}_{mk} - {P}_{ek} - {D}_{k} \frac{{ω}_{k} - {ω}_{R}}{{ω}_{R}} ) \\ {\dot{e}}_{qk}^{′} = \frac{1}{{T}_{d 0 k}^{′}} [ {E}_{fdk} - {e}_{qk}^{′} - ( {x}_{dk} - {x}_{dk}^{′} ) {i}_{dk} ] \\ {\dot{e}}_{dk}^{′} = \frac{1}{{T}_{q0k}^{′}} [ - {e}_{dk}^{′} + ( {x}_{qk} - {x}_{qk}^{′} ) {i}_{qk} ]\end{matrix} & ( 13 ) \\ {E}_{k} = {e}_{dk}^{′} sin {δ}_{k} + {e}_{qk}^{′} cos {δ}_{k} + j ( {e}_{qk}^{′} sin {δ}_{k} - {e}_{dk}^{′} cos {δ}_{k} ) \\ {I}_{tk} = {i}_{Rk} + {ji}_{Ik} {=}^{def} {Y}_{k}^{*} E \\ {P}_{ek} = {e}_{qk} {i}_{qk} + {e}_{dk} {i}_{dk} \\ \begin{matrix}{i}_{qk} = {i}_{Ik} sin {δ}_{k} + {i}_{Rk} cos {δ}_{k} , & {i}_{dk} = {i}_{Rk} sin {δ}_{k} - {i}_{Ik} cos {δ}_{k} \\ {e}_{qk} = {e}_{qk}^{′} - {x}_{dk}^{′} {i}_{dk} , & {e}_{dk} = {e}_{dk}^{′} - {x}_{qk}^{′} {i}_{qk}\end{matrix} \\ & ( 14 )\end{matrix}$$

In equations (13) and (14), ω_{R} is a rated angular frequency (i.e., the synchronous frequency of the system); δₖ, ωₖ, Hₖ and Dₖ are respectively a rotor angle, a rotor speed, an inertia coefficient and a damping coefficient of the machine k; Yₖ is the k^{th} row of a reduced admittance matrix Y; E is the column vector of electromagnetic forces (EIVIFs) of all the machines, wherein Eₖ is the k^{th} element; Pₘₖ and Pₑₖ are mechanical and electric powers; E_{fdk} is an internal field voltage; and e′_{qk}, e′_{dk}, i_{qk}, i_{dk}, T′_{q0k}, x_{qk}, x_{dk}, x′_{qk} and x′_{dk} are transient voltages, stator currents, open-circuit time constants, and q-axis and d-axis synchronous and transient reactances, respectively.

The algebraic equations (14) may be substituted into differential equations (13) to eliminate i_{gk}, i_{dk} and Pₑₖ and transform equations (13) and (14) into the form of equation (4), where there are M=4K state variables: x=[δ₁, ω₁, e′_{q1}, e′_{d1}, . . . , δ_{K}, ω_{K}, e′_{qK}, e′_{dK}]^{T}. Then, equations (6)-(12) may be applied to derive an SAS for each of the state variables.

Further consider a system comprising a single machine connected to an infinite bus (i.e., a typical single-machine infinite-bus (SMIB) system) with a state vector x=[δ, ω,e′_{q}, e′_{d}]^{T}, a vector function f=[f₁,f₂,f₃, f₄]^{T}, and the infinite bus has a voltage V_{∞}=1∠0° per unit (p.u.). Based on the assumption of equation (7), each state variable of the state vector x may be decomposed as a summation of infinite terms as in equation (15).

δ(t)=Σₙ₌₀⁴δₙ(t)

ω(t)=Σₙ₌₀^{∞}ωₙ(t)

e′_{d}(t)=Σₙ₌₀⁴e′_{d,n}(t)

e′_{q}(t)=Σₙ₌₀⁴e′_{q,n}(t) (15)

With the machine rotor speed ω as example, applying Laplace transform as in equation (6) results in equation (16).

$$[ ω ] = \frac{ω ( 0 )}{s} + \frac{ [ {f}_{2} ( δ , ω , {e}_{q}^{′} , {e}_{d}^{′} ) ]}{s} \qquad ( 16 )$$

Then, a plurality of Adomian polynomials for f₂ may be determined by applying equations (8) and (9). For example, the first two Adomian polynomials are given in equation (17), wherein Yₒ and Y_{∞} are respectively a self-admittance seen from the machine's EMF and an admittance to the infinite bus.

$$\begin{matrix}\begin{matrix}{A}_{2 , 0} = \frac{{ω}_{R}}{2 H} [ - {e}_{q , 0}^{′} {γ}_{1} - {e}_{d , 0}^{′} {γ}_{2} + {γ}_{1} {γ}_{2} ( {x}_{d}^{′} - {x}_{q}^{′} ) + \\ {P}_{m} - D \frac{{ω}_{0} - {ω}_{R}}{{ω}_{R}} ] \\ {A}_{2 , 1} = \frac{{ω}_{R}}{2 H} [ {Y}_{o} {x}_{d}^{′} ( {e}_{q , 1}^{′} {γ}_{2} + {e}_{d , 1}^{′} {γ}_{1} ) - {δ}_{1} {Y}_{∞}^{2} ( {x}_{d}^{′} - {x}_{q}^{′} ) cos 2 {δ}_{0} - \\ 2 {Y}_{∞} ( {e}_{q , 0}^{′} {e}_{q , 1}^{′} + {e}_{d , 0}^{′} {e}_{d , 1}^{′} ) - {Y}_{∞} ( {e}_{d , 1}^{′} cos {δ}_{0} - {e}_{q , 1}^{′} sin {δ}_{0} ) - \\ {x}_{d}^{′} {Y}_{o} {γ}_{4} + {Y}_{o} {Y}_{∞} {δ}_{1} {x}_{q}^{′} {γ}_{4} + {Y}_{∞} {δ}_{1} {γ}_{3} - {Y}_{o} {x}_{q}^{′} ( {e}_{d , 1}^{′} {γ}_{1} + {e}_{q , 1}^{′} {γ}_{2} ) - \\ \frac{D {ω}_{1}}{{ω}_{R}} ]\end{matrix} & ( 17 ) \\ where \begin{matrix}{γ}_{1} = {Y}_{o} {e}_{q , 0}^{′} - {Y}_{∞} sin {δ}_{0} \\ {γ}_{2} = {Y}_{o} {e}_{d , 0}^{′} + {Y}_{∞} cos {δ}_{0} \\ {γ}_{3} = {e}_{q , 0}^{′} cos {δ}_{0} + {e}_{d , 0}^{′} sin {δ}_{0} \\ {γ}_{4} = {e}_{d , 0}^{′} cos {δ}_{0} + {e}_{q , 0}^{′} sin {δ}_{0}\end{matrix} & \end{matrix}$$

Similarly, a plurality of Adomian polynomials may be derived for the machine rotor angle δ, q-axis transient voltage e′_{q}, and d-axis transient voltage e′_{d}. Further, recursive formulas like formulas (10) and (11) may be derived and inverse Laplace transform may be applied to derive δₙ(t), ωₙ(t), e′_{q,n}(t), and e′_{d,n}(t) for any n. SASs for δ(t), ω(t), e′_{q}(t), and e′_{d}(t) may then be defined as the sum of the first N terms as in equation (18).

$$\begin{matrix}{δ}^{SAS} ( t ) = {\sum }_{n = 0}^{N - 1} {δ}_{n} ( t ) \\ {ω}^{SAS} ( t ) = {\sum }_{n = 0}^{N - 1} {ω}_{n} ( t ) \\ {e}_{q}^{′ SAS} ( t ) = {\sum }_{n = 0}^{N - 1} {e}_{q , n}^{′} ( t ) \\ {e}_{d}^{′ SAS} ( t ) = {\sum }_{n = 0}^{N - 1} {e}_{d , n}^{′} ( t )\end{matrix} \qquad ( 18 )$$

For example, for system parameters and initial conditions listed in Table I, the first five terms for δₙ(t) may be derived as in equation (19) and an SAS with N=5 may thus be defined as in equation (20). In Table I, |E| is a magnitude of the EIVIF of the machine and is assumed to be constant. Pₘ represents a mechanical power that determines the operating condition. δ(0) and ω(0) are the initial values of the rotor angle δ and the rotor speed ω, respectively.

TABLE I

| H | D | Y_{∞} | Yₒ | Pₘ |
|---|---|---|---|---|
| 3 s | 0 s | 0.9 ∠ 90° p.u. | 0 p.u. | 0.8 p.u. |
| \|E\| | V_{∞} | ω_{R} | δ(0) | ω(0) |
| 1.1 p.u. | 1 ∠ 0° | 377 rad/s | 0.06 rad | 2.05 rad/s |

$$\begin{matrix}{δ}_{0} ( t ) = 0.06 \\ {δ}_{1} ( t ) = 20.81 {t}^{2} + 2.05 t \\ {δ}_{2} ( t ) = - 241.61 {t}^{4} - 47.72 {t}^{3} \\ {δ}_{3} ( t ) = 1184.67 {t}^{6} + 350.95 {t}^{5} + 1.52 {t}^{4} \\ {δ}_{4} ( t ) = 11.39 {t}^{8} + 4.50 {t}^{7} + 168.66 {t}^{6} + 10.07 {t}^{5} & ( 19 ) \\ \begin{matrix}{δ}^{SAS} ( t ) = {\sum }_{n = 0}^{4} {δ}_{n} ( t ) = 11.39 {t}^{8} + 4.50 {t}^{7} + 1353.32 {t}^{6} + 361.02 {t}^{5} - \\ 240.09 {t}^{4} - 47.72 {t}^{3} + 20.81 {t}^{2} + 2.05 t + 0.06\end{matrix} & ( 20 )\end{matrix}$$

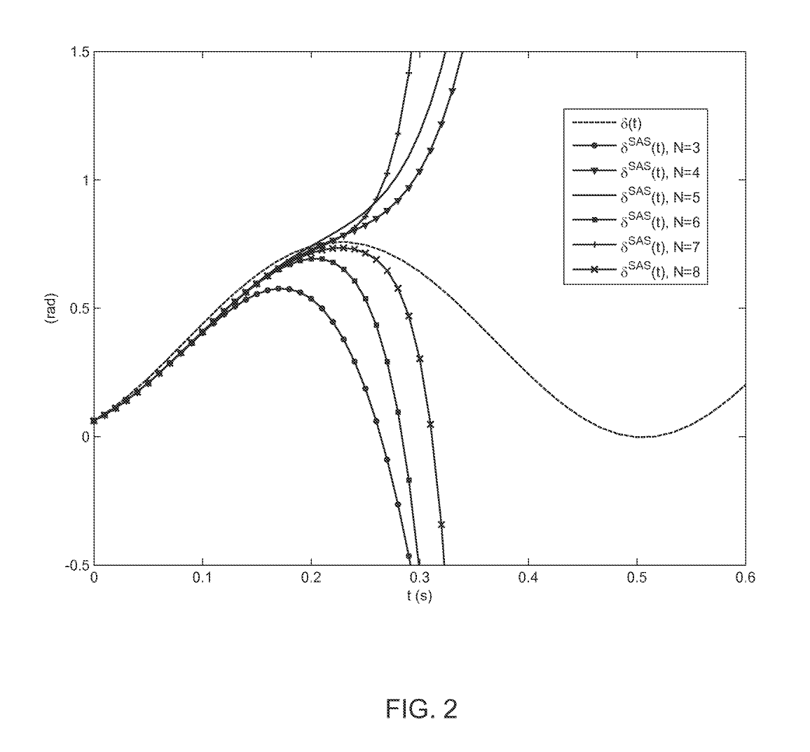

Depending on the number of terms N, a plurality of SASs may be derived for each state variable. FIG. 2 illustrates six SASs δ^{SAS}(t) with N={3, 4, . . . , 8}, along with a numerical solution δ(t) obtained from a numerical integration method such as fourth-order Runge-Kutta (R-K 4), evaluated over 0.6 seconds. As can be seen, the six SASs match the numerical solution OM for a short period of time, and the time window of accuracy is wider as the number of terms N increases. However, as the number of terms N increases, the complexity of the SAS increases, leading to an increase in computation time.

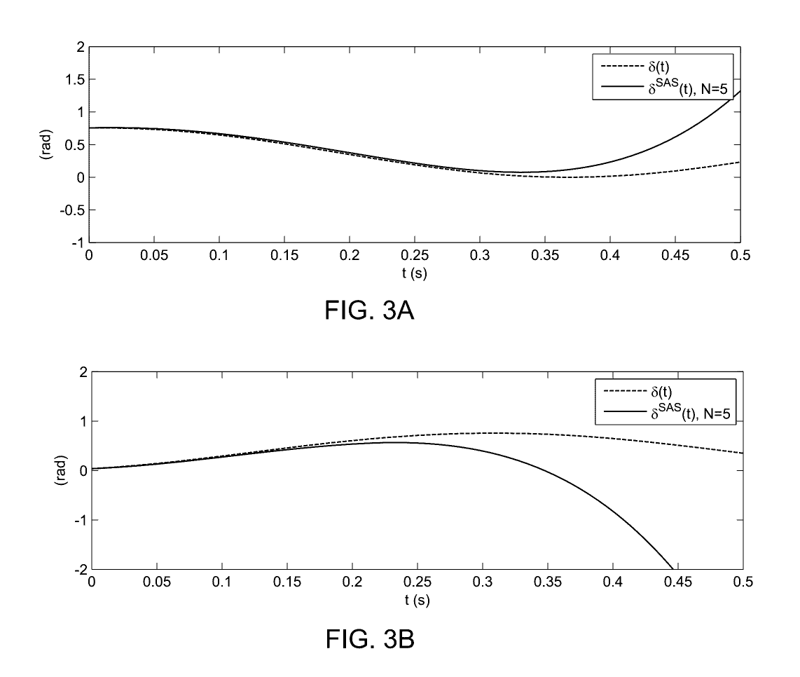

FIGS. 3A and 3B illustrate the SAS δ^{SAS}(t) with N=5 and the numerical solution δ(t), but for ω(0)=0 rad/s and a large ω(0)=1.4 rad/s, respectively. As can be seen, when ω(0)=0, the time window of accuracy is about 0.25 seconds. When |ω(0)| is large, the time window of accuracy is less than 0.2 seconds. Thus, the time window of accuracy depends on the initial conditions provided for the state variables. Moreover, experiments have shown that the time window of accuracy also depends on the contingency.

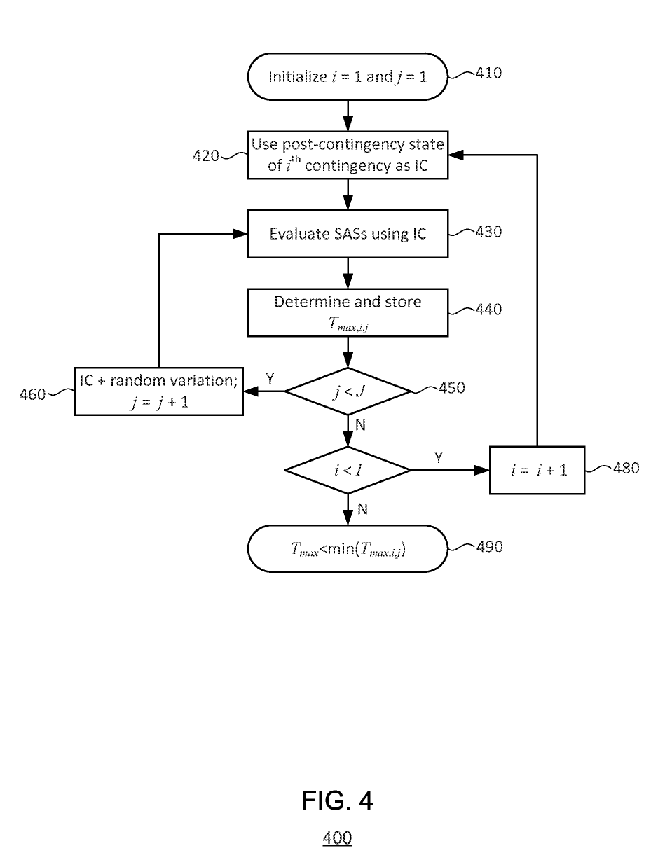

FIG. 4 illustrates a method 400 of determining a maximum duration Tₘₐₓ, according to an embodiment of the present disclosure. The maximum duration Tₘₐₓ may be determined to be used for fixed time windows such that all the SASs for the state variables of a power system remain accurate within the time windows. The method 400 may be performed offline at step 113 of the method 100, for example.

The method 400 starts at step 410, where two indices i and j are each initialized to one. At step 420, the method 400 obtains the post-contingency state of an i^{th} contingency of a power system, out of a total number I of credible contingencies for the power system, for example. The post-contingency state may be obtained from a numerical integration of the system. Then, at step 430, the post-contingency state is used as an initial condition (IC) to evaluate an SAS (x^{SAS}(t)) corresponding to the contingency over a time window chosen to be long enough to observe divergence between the SAS and a corresponding numerical solution x(t) (e.g., as in FIG. 2). Once the SAS is evaluated, the method 400 determines and stores at step 440 a maximum duration T_{max,i,j}. For example, the maximum duration T_{max,i,j} may be determined based on equation (21), wherein ε is a small number.

$${T}_{max , i , j} = \{ \begin{matrix}t , when {x}_{i , j}^{SAS} ( t ) > {x}_{i , j} ( t ) + ɛ \\ t , when {x}_{i , j}^{SAS} ( t ) < {x}_{i , j} ( t ) - ɛ\end{matrix} \qquad ( 21 )$$

At step 450, if the index j is less than a predetermined number J (say three), the method 400 moves to step 460, where the index j is incremented and a random variation is added to the initial condition. Steps 430-460 are repeated until the index j equals the predetermined number J. At step 470, if the index i is less than the number I of credible contingencies, the method 400 increments i at step 480 and repeats step 420-470 until the index i equals the number I of credible contingencies. At step 490, the maximum duration Tₘₐₓ is chosen to be less than the minimum T_{max,i,j} stored, for all i and j. Thus, the method 400 may determine a conservative maximum duration Tₘₐₓ for a power system by simulating the power system under a plurality of contingencies and a plurality of initial conditions for each contingency.

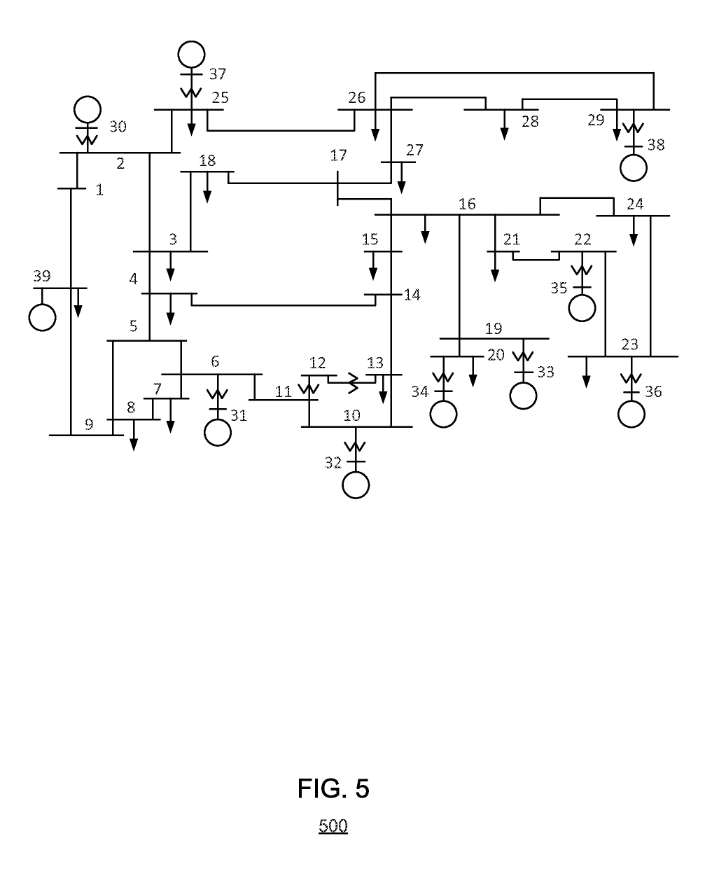

Once a maximum duration Tₘₐₓ for a power system is determined, an SAS for the power system may be evaluated online over consecutive time windows, each time window lasting for the maximum duration Tₘₐₓ. The evaluation of the SAS may be performed during the online stage 120 of the method 100, following the steps 121-126. For example, consider a power system 500 illustrated in FIG. 5. The power system 500 corresponds to the IEEE 10-generator, 39-bus power system, which is a case study commonly employed in the power system field. Since the generator 39 (i.e., the generator at the bus 39) has the largest inertia and its rotor angle δ₃₉ is typically defined as the reference for the other nine generators' rotor angles (δ₃₀ through δ₃₈). The power system 500 may be modeled as in equations (13) and (14), and an SAS may be derived for each state variable by applying equations (6)-(12).

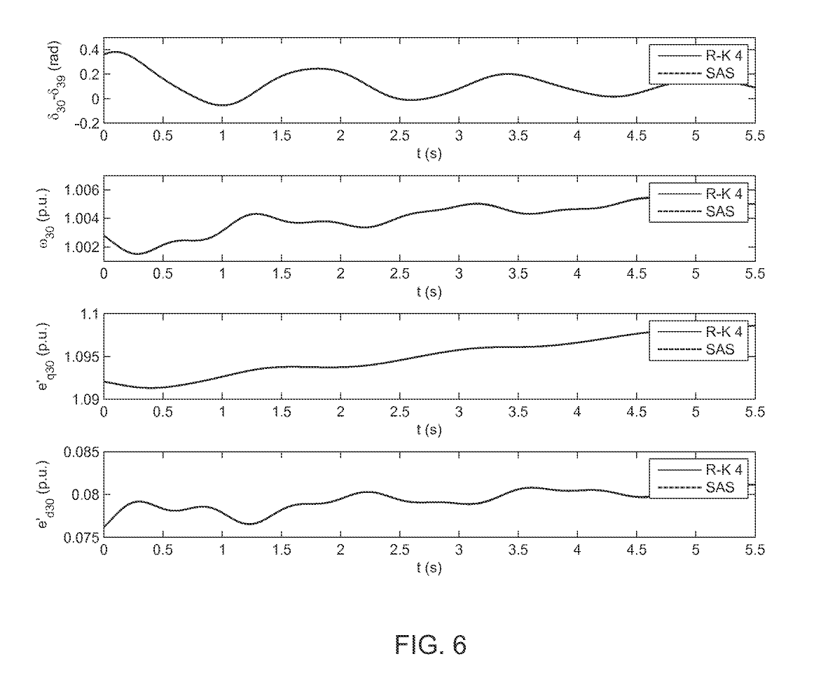

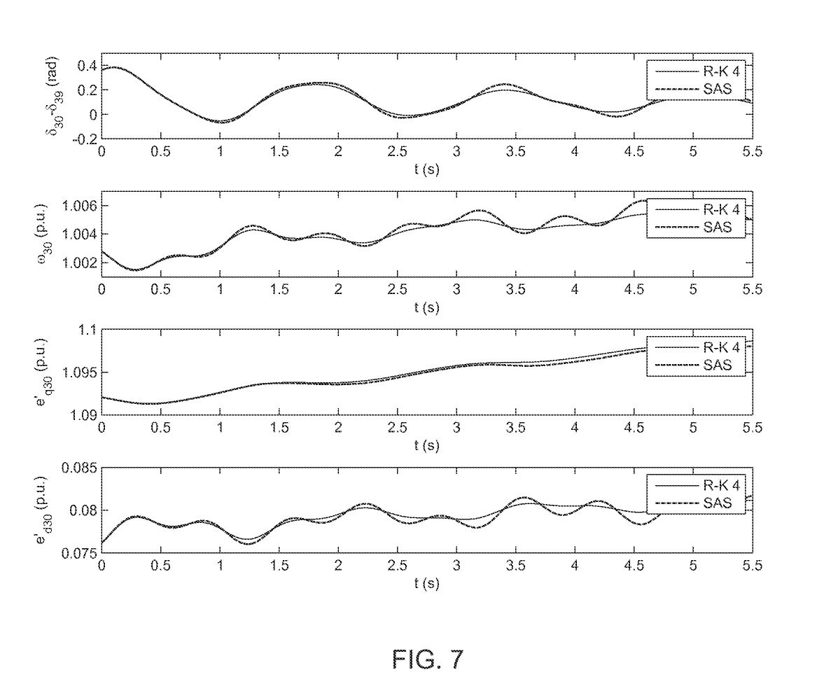

Applying the method 400 to the power system 500, a maximum duration Tₘₐₓ is determined to be 0.001 seconds for two-term SASs (i.e., N=2). FIG. 6 illustrates trajectories for the four state variables (δ₃₀-δ₃₉), ω₃₀, e′_{q30}, and e′_{d30} associated with the generator 30 after a three-phase fault lasting for 0.08 seconds on the transmission line connecting the bus 3 to the bus 4, near bus 3. Plotted for each of the four state variables are a trajectory obtained by evaluating a corresponding two-term SAS using consecutive 0.001-second time windows and another trajectory for a numerical solution from an R-K 4 simulation. As can be seen, the trajectories of the SASs are identical to and thus overlap the R-K 4 numerical solutions. FIG. 7 illustrates similar trajectories, but with the SASs evaluated over wider 0.01-second time windows. As can be seen, there are noticeable differences between the SAS trajectories and the R-K 4 trajectories due to the inaccuracy of the two-term SASs over 0.01-second time windows.

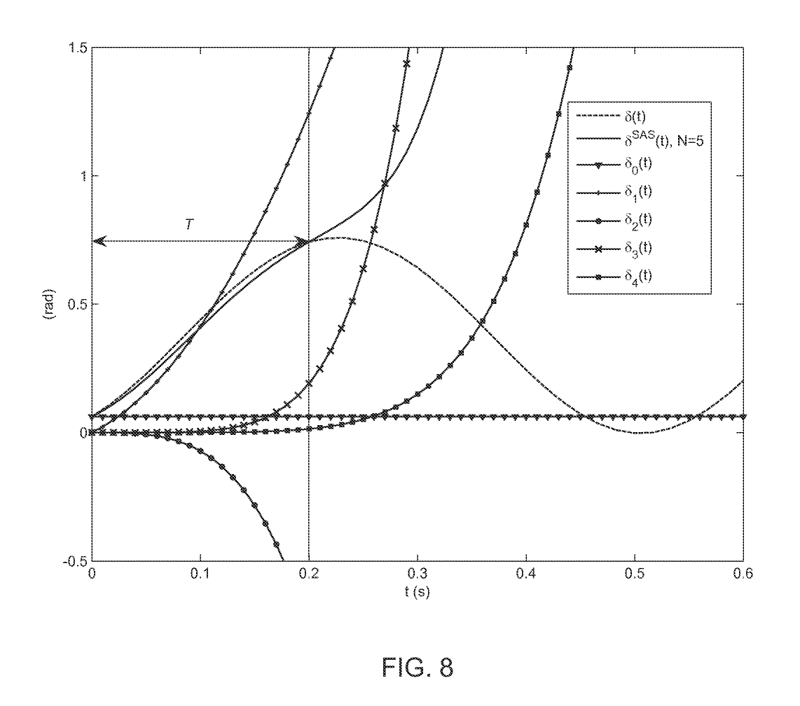

Alternatively, as discussed, adaptive time windows may be employed in conjunction with a maximum threshold I_{D max} for a divergence indicator I_{D}. According to an embodiment of the present disclosure, the magnitude of the last term of the SAS, i.e., |x_{N-1}(t)|, has been found to be a good candidate for a divergence indicator I_{D}. For instance, FIG. 8 illustrates the five-term (i.e., N=5) SAS δ^{SAS}(t) given in equation (20), along with the first five terms for δₙ(t) given in equation (19) and the R-K 4 numerical solution δ(t) (as in FIG. 2). FIG. 8 shows a time window T during which the SAS δ^{SAS}(t) is accurate when compared to the numerical solution δ(t). As can be seen, among the five terms included in the SAS, |δ₄(t)| is closest to zero within the time window T and sharply increases in magnitude otherwise. A maximum threshold I_{D,max} may be determined to guarantee accuracy of the SAS such the divergence indicator I_{D} reaches a maximum threshold I_{D,max} at the end of the time window T. In the case of FIG. 8, the maximum threshold I_{D,max} may be chosen to be 0.01 radians to correspond to the duration T. As the divergence indicator I_{D} varies for different contingencies and initial conditions, the time at which the divergence indicator I_{D} reaches the maximum threshold I_{D,max} may vary, thus resulting in adaptive time windows.

However, in a system that includes a plurality of state variables, determining a divergence indicator I_{D} and a maximum threshold I_{D,max} may not be as straightforward as the example of FIG. 8. For instance, FIG. 8 focuses on |δ_{N-1}(t)|, but one of |ω_{N-1}(t)|, |e′_{q,N-1}(t)|, and |e′_{d,N-1}(t)| may turn out to be a better candidate for the divergence indicator I_{D}. Moreover, the trajectories for |δ_{N-1}(t)|, |ω_{N-1}(t)|, |e′_{q,N-1}(t)|, and |e′_{d,N-1}(t)| vary as the contingencies and the initial conditions (e.g., δ(0)) change.

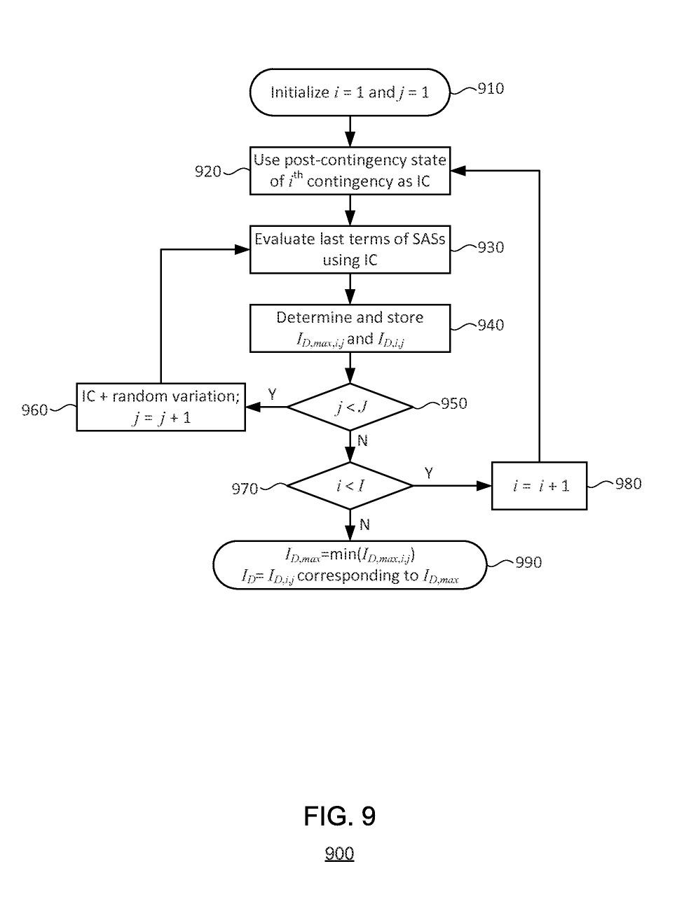

FIG. 9 illustrates a method 900 of determining a maximum threshold I_{D,max} and an associated divergence indicator I_{D}, according to an embodiment of the present disclosure. The method 900 may be applied at step 113 of the method 100, for example. The method 900 starts at step 910, where two indices i and j are each initialized to one. At step 920, the method 900 obtains the post-contingency state of an i^{th} contingency of a power system, out of a total number I of credible contingencies for the power system, for example. The post-contingency state may be obtained from a numerical integration of the system. Then, at step 930, the post-contingency state is used as an initial condition (IC) to evaluate a last term of each SAS for each state variable of the power system (i.e., x_{N-1}(t)) over consecutive fixed time windows. The duration of the each fixed time window is chosen to be short enough (say 0.001 seconds) to guarantee accuracy of the SAS in each window.

Once the last terms of the SASs are evaluated, the method 900 determines and stores at step 940 a maximum absolute value among the last terms as I_{D,max,i,j} (i.e., I_{D,max,i,j}=max(|x_{N-1,i,j}(t)|)), and the corresponding last term as I_{D,i,j}. At step 950, if the index j is less than a predetermined number J (say three), the method 900 moves to step 960, where the index j is incremented and a random variation is added to the initial condition. Steps 930-960 are repeated until the index j equals the predetermined number J. At step 970, if the index i is less than the number I of credible contingencies, the method 900 increments i at step 980 and repeats step 920-970 until the index i equals the number I of credible contingencies.

The method 900 ends at step 990, where the maximum threshold I_{D,max} is determined to be the minimum I_{D,max,i,j} stored and the divergence indicator I_{D} as the I_{D,i,j} corresponding to the maximum threshold I_{D,max} for all i and j. Thus, the method 900 may determine a maximum threshold I_{D,max} and a corresponding divergence indicator I_{D} for a power system by simulating the power system under a plurality of contingencies and a plurality of initial conditions for each contingency.

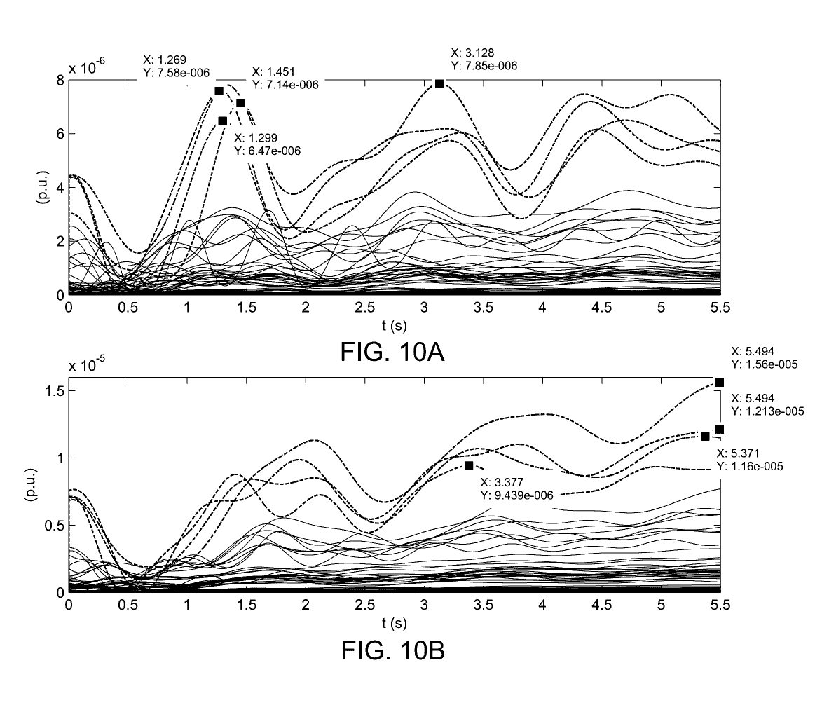

FIGS. 10A and 10B illustrate an exemplary application of the method 900 to the power system 500 of FIG. 5 under a first contingency and a second contingency (i.e., I=2), respectively, to determine a maximum threshold I_{D,max} and a divergence indicator I_{D}. The first contingency involves a three-phase fault lasting for 0.08 seconds near bus 3 on the transmission line connecting the bus 3 to the bus 4, and the second contingency a three-phase fault also lasting for 0.08 seconds near bus 15 on the transmission line connecting the bus 15 to the bus 16. Three random variations are added to the post-contingency initial conditions (i.e., J=4). For the first contingency and second contingency, respectively, FIGS. 10A and 10B illustrate trajectories of third terms of three-term SASs for the state variables (excluding rotor angles) of the power system 500 (i.e., x₂(t)) evaluated over a time period of 5.5 seconds using fixed time windows lasting 0.001 seconds each. For each contingency, a maximum value (e.g., determined at step 940) among all the third terms of the SASs is indicated for each variation in initial condition. All the maximum values are associated with |e′_{q34,2}| (dashed lines). Therefore, I_{D,max}=min(I_{D,max,i,j})=6.5×10⁻⁶ p.u. and the divergence indicator I_{D} is |e′_{q34,2}| (e.g., at step 990). Although this example uses two contingencies and three random variations of the initial conditions, in practice, a plurality of contingencies and random variations may be used to determine a maximum threshold and a divergence indicator I_{D}.

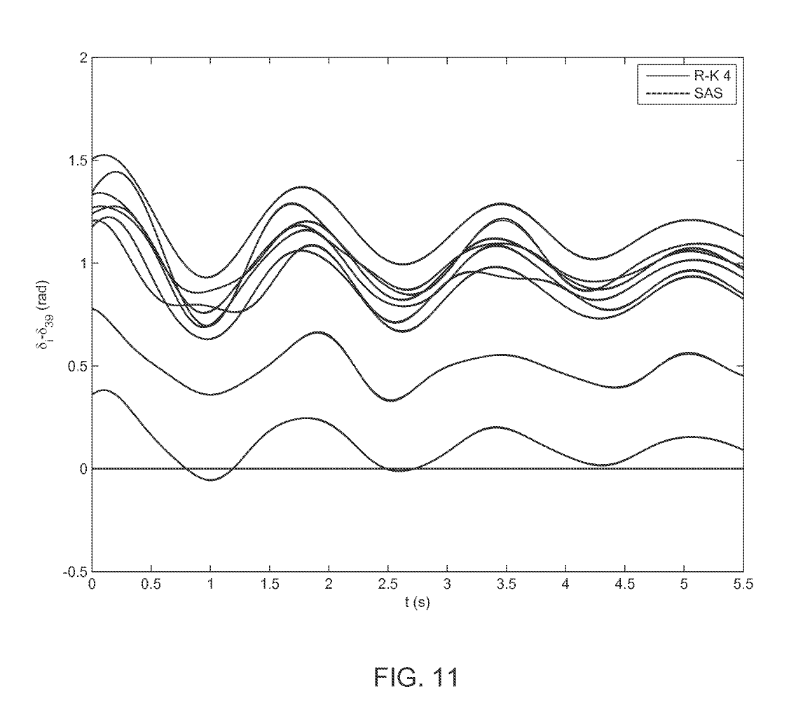

FIG. 11 illustrates trajectories for the rotor angles δᵢ, i=30 through 39, of the ten generators of the power system 500 of FIG. 5, referred to the rotor angle δ₃₉ of the generator 39. Plotted for each rotor angle are a trajectory obtained by evaluating a corresponding three-term SAS using adaptive time windows for a 5.5 seconds time period and another trajectory for a numerical solution from an R-K 4 simulation. As can be seen, there is a good match between the trajectories of the SASs and the R-K 4 numerical solutions.

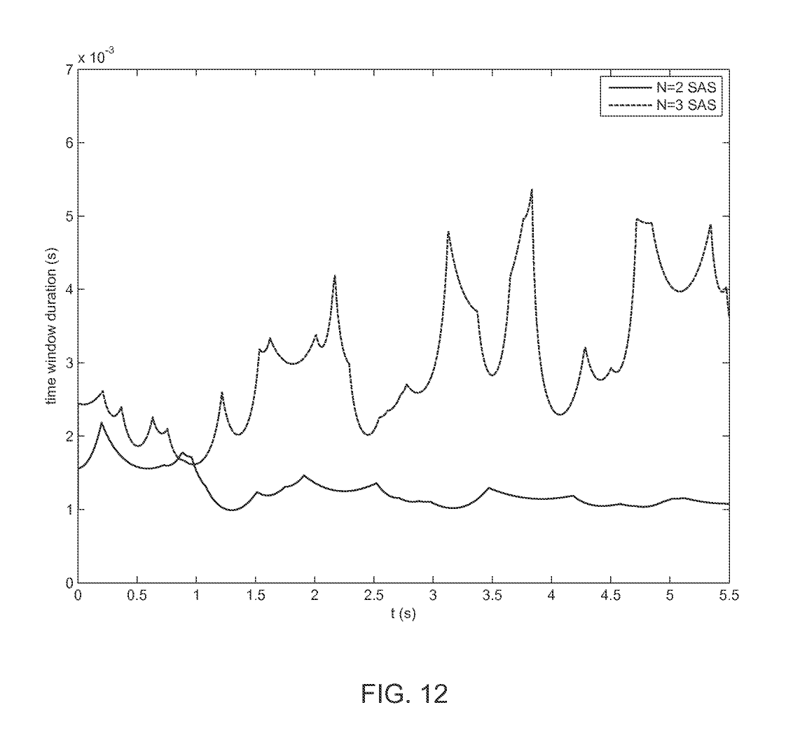

FIG. 12 illustrates variations in adaptive time window durations when evaluating two-term SASs and three-term SASs for the state variables of the power system 500 of FIG. 5. As can be seen, over a time period of 5.5 seconds, the adaptive time windows are longer for the three-term SASs. The longest duration for the adaptive time windows reaches 0.0022 seconds for the two-term SASs, and 0.005 seconds for the three-term SASs. Thus, over a given simulation time period, fewer adaptive time windows are required when compared to fixed time windows. Moreover, the higher the order of the SAS, the longer are the adaptive time windows and the fewer are the total number of windows required to simulate state trajectories over a given simulation time period. As an exemplary comparison, for a 5.5-second simulation time period, fixed 0.001-second time windows results in a total of 5500 windows, adaptive time windows with a two-term SAS 4500 windows, and adaptive time windows with a three-term SAS 2000 windows.

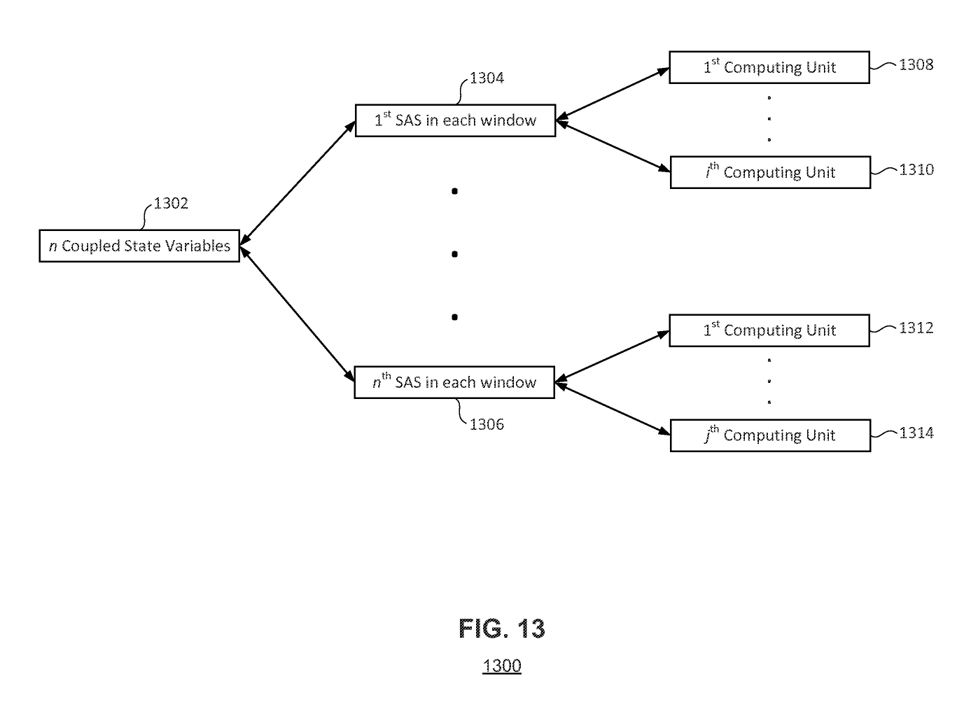

FIG. 13 illustrates a parallel computation 1300 of an SAS-based simulation of a power system, according to an embodiment of the present disclosure. At stage 1302, each machine in a power system may be represented by n coupled state variables. For example, the four state variables (i.e., n=4) in equation (13) are coupled through nonlinear algebraic equations (14). As discussed, an SAS may be derived for each of the n state variables, as in equation (18), for example. Given that the SASs are independent expressions within each time window, their evaluations may be performed simultaneously on parallel processors as in stages 1304, 1306. After the parallel evaluations of the SASs in the current window are completed, the ending values of the SASs at the end of the window may be collected and sent back to stage 1302 to be utilized as initial values for the SASs in the next window.

Furthermore, each SAS may be expressed as a summation of a plurality of terms called computing units (CUs) herein. Each computing unit may be in the form of equation (22).

$$C \cdot \underbrace{{x}_{i} … {x}_{j} {t}^{n}}_{h} \underbrace{{f}_{k} ( {x}_{k} ) … {f}_{l} ( {x}_{l} )}_{m} where f ( \cdot ) is sin ( \cdot ) or cos ( \cdot ) \qquad ( 22 )$$

In equation (22), C is a constant that may depend on system parameters, t is time, and j, k and l are integer indices of state variables. Parameters h, m, and n depend on the order of the SAS and the system being simulated. For example, for the power system 500 of FIG. 5, if three-term SASs are employed, then h may range from 0 to 3, n from 0 to 2, and m from 0 to 4. Thus, the SASs associated with a machine do not necessarily include the same number of CUs. For every SAS, its CUs may be evaluated simultaneously on parallel processors, as illustrated by stages 1308-1314.

Simulating the state trajectories of each machine using the parallel computation 1300, and also running a plurality of the parallel computations 1300 for a plurality of machines in a power system may considerably reduce the overall computation time for a typical simulation time period when compared to conventional power system simulation techniques.

To demonstrate the time performance of the SAS-based simulation, consider the following three cases, all related to the power system 500 of FIG. 5:
Case-A: time t and initial state variables are symbolized.
Case-B: in addition to Case-A, the reduced admittance matrix Y about the EMFs of the ten generators also are symbolized, i.e., to simulate different faults under one specific loading condition. Magnitudes and angles of elements of the reduced admittance matrix Y are symbolized separately to generate two symmetric symbolic 10×10 matrices.
Case-C: in addition to Case-B, the generators' mechanical powers are symbolized to allow the SASs to simulate various loading conditions.

In the above cases, the load at each bus is represented by a constant impedance load model and is embedded in the reduced admittance matrix Y. In the online stage, for a given power-flow condition with all loads known, load impedances are first calculated, and then with the knowledge of the post-contingency network topology, all elements of Y can be calculated in order to evaluate the SASs.

The numbers of CUs included in three-term SASs of each state variable are given in Table II for the three cases.

TABLE II

| State Variable | Case-A | Case-B | Case-C |
|---|---|---|---|
| ωₖ | 4269 | 11430 | 11430 |
| δₖ | 150 | 150 | 150 |
| e′_{qk} | 225 | 301 | 301 |
| e′_{dk} | 223 | 299 | 299 |

For Case-A, it takes less than 3 μs to evaluate one CU. If the CUs are evaluated simultaneously on parallel processors, it takes about 3 μs to evaluate one SAS for each time window. Summating the values of all CUs for a state variable is essentially the addition of constants and is, therefore, extremely fast. The additions for different state variables can also be performed in parallel. Thus, the final time for summating all CUs equals the time for the most complex SAS expression, which is often related to a rotor angle of a generator and takes about 7 μs. Therefore, the total time for evaluations of state variables of one generator is about 10 μs per time window. If evaluations for various generators are also done simultaneously, the SAS evaluation over each time window also takes about 10 μs. Given that a three-term SAS takes 2000 adaptive time windows for a 5.5-second simulation, as discussed above, the online stage 120 of the method 100 may take 10 μs×2000=0.02 seconds to finish the simulation on parallel processors. This is found to be about 18 times faster than simulating the same power system by an R-K 4 method on one computer, which has been found to take about 0.37 seconds. Thus, for Case-A, running a 5.5-second simulation time period in 0.02 seconds implies that the simulation may be completed 275 times faster than real time. For Case-B and Case-C, the SAS-based simulation has been found to be 137.5 times faster than real time. It is to be noted that the time performance of the offline stage 110 of the method 100 does not affect the time performance of the online stage 120.

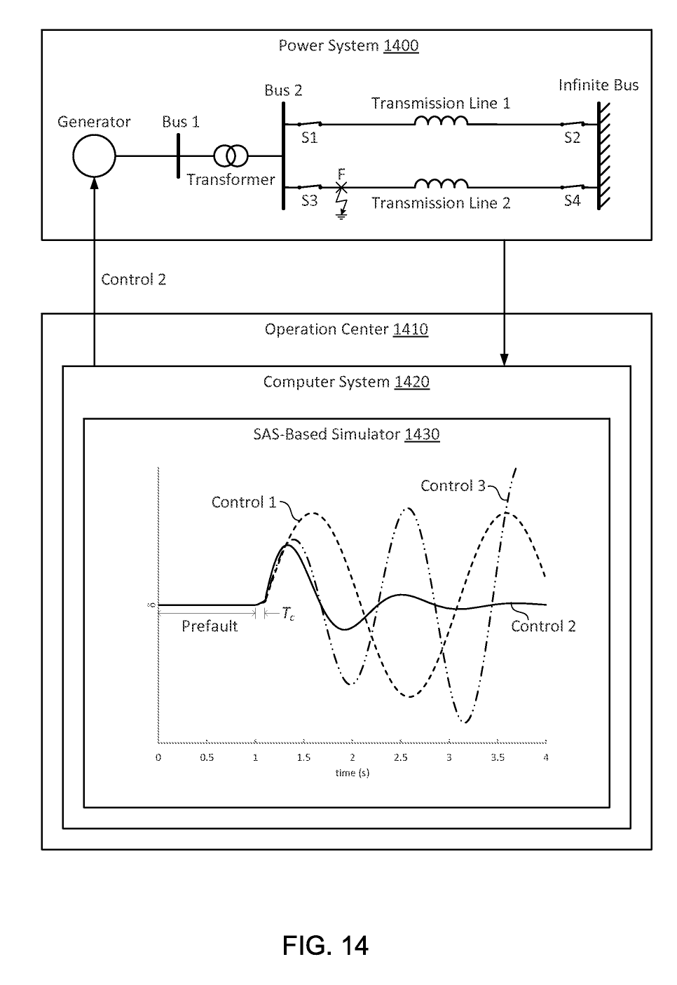

FIG. 14 illustrates an exemplary application of an SAS-based simulation to a power system according to an embodiment of the present disclosure. In FIG. 14, a power system 1400 may be overseen by operators in an operation center 1400, which may include a computer system 1420 to run, among other things, an SAS-based simulator 1430 to simulate the power system 1400 following a contingency.

In FIG. 14, the power system 1400 is shown as, but is not limited to, a hypothetical single-machine infinite-bus (SMIB) power system, wherein a generator supplies power to an infinite bus through two transmission lines 1 and 2. A voltage provided by the generator at a bus 1 may be boosted by a transformer and supplied to a bus 2 driving the two transmission lines 1 and 2. The infinite bus may represent a large system of interconnected generators, buses, transmission lines, switches, transformers, capacitors, power-consuming loads, etc.

Consider a three-phase fault F occurring on transmission line 2 at time=1 second, prior to which (i.e., prefault) the power system 1400 ran stably as shown by the constant rotor angle δ of the generator. It may take a clearing time of T_{C} seconds (e.g., 0.1 seconds) to clear the fault, by opening switches S3 and S4, for example. As soon as the fault is cleared, the SAS-based simulator 1430 may be run on the computer system 1420 to simulate faster than real time (e.g., in 0.02 seconds) a plurality of remedial actions and generate state trajectories for the power system for each remedial action. For example, the SAS-based simulator 1430 may simulate three scenarios in which the generator may be controlled using one of Controls 1 through 3. For each control, the simulator 1430 may generate and display the state trajectories over a desired simulation time period. Exemplary state trajectories for the rotor angle δ of the generator are illustrated in FIG. 14 for each of the three controls. Based on these state trajectories, the best remedial action may be taken. In this case, the rotor angle δ is found to be marginally stable under Control 1, stable under Control 2, and unstable under Control 3. Unlike Controls 1 and 3, Control 2 results in the rotor angle 6 of the generator returning stably to its prefault value. Since stability is desired, once the SAS-based simulation is completed (e.g., soon after time=1.12 seconds), a control signal may be sent from the operation center 1410 to the power system 1400 to place the generator in Control 2 mode, such that the generator and the power system may continue to operate stably after the contingency.

Although, in the example of FIG. 14, three remedial scenarios to control one generator are evaluated, it is to be appreciated that, in practice, following a contingency, there may exist a myriad of remedial scenarios to control a myriad of elements of a power system.

Moreover, each remedial scenario may not be limited to controlling one element of the power system. The most effective remedial may be a combination of a plurality of controls of a plurality of elements. For example, in addition to changing the control of a generator, one or more transmission lines may be isolated by opening and/or closing switches to effectively change the admittance matrix of the power system. Another example may be to bring a standby generator online. The SAS-based simulation thus may allow operators to study and analyze faster than real time the performances of a plurality of possible remedial scenarios following a contingency, and, as a result, take the most effective remedial action.

The computer system 1420 may include a plurality of processors to run the SAS-based simulator 1430 to evaluate a plurality of SASs in parallel, as discussed. The computer system 1420 may also run one or more numerical integration simulations to provide post-contingency states to the SAS-based simulator 1430. The computer system 1420 may include secondary or tertiary storage to allow for non-volatile or volatile storage of the plurality of SASs for a plurality of contingencies, maximum durations Tₘₐₓ, maximum thresholds I_{D,max}, divergence indicators I_{D}, post-contingency states, initial conditions, and other data required by the SAS-based simulator 1430 and data generated by the SAS-based simulator 1430 for subsequent analyses. The computer system may also include one or more display units to display state trajectories generated by the SAS-based simulator 1430 for review and analysis by the operators. The computing system may be entirely contained at one location or may also be implemented across a closed or local network, an internet-centric network, or a cloud platform. It is to be appreciated that the SAS-based simulation is not limited to any particular programming language or execution environment, and the present invention may be applied to any computer programming languages or logic.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure. Further variations are permissible that are consistent with the principles described above.

What is claimed is:

1. A method of operating a power system, comprising:
deriving a plurality of semi-analytic solutions (SASs), wherein each SAS relates to at least one of a plurality of power system state variables;
evaluating, with a plurality of processors, the plurality of SASs in parallel and consecutively over a plurality of time windows; and
controlling at least one power system element based on the evaluation of at least one of the SASs.

2. The method of claim 1, wherein the at least one power system element includes one or more generators, switches, transformers, capacitors, and power-consuming loads.

3. The method of claim 1, wherein
each of the plurality of SASs is a summation of a plurality of terms,
each term includes a plurality of computing units, and
the computing units are evaluated in parallel using a plurality of processors.

4. The method of claim 1, wherein deriving a plurality of SASs comprises:
generating a model of the power system; and
applying an Adomian decomposition method to the model.

5. The method of claim 1, further comprising:
determining a fixed duration for each of the plurality of time windows by comparing at least one of the plurality of SASs to numerical solutions for a plurality of contingencies of the power system and a plurality of initial conditions for each contingency.

6. The method of claim 1, further comprising:
determining an indicator and a maximum threshold for the indicator by evaluating last terms of each of the plurality of SASs for a plurality of contingencies of the power system and a plurality of initial conditions for each contingency; and
adaptively varying durations of the plurality of time windows by comparing the indicator to the maximum threshold during each time window.

7. The method of claim 6, wherein the indicator is a magnitude of one of the last terms of each of the plurality of SASs.

8. The method of claim 1, further comprising:
obtaining, from a numerical simulation of the power system, initial conditions for evaluating the plurality of SASs in a first time window of the time windows; and
for each subsequent time window, using ending states of at least one of the plurality of SASs in a preceding time window as initial conditions for evaluating the plurality of SASs in the subsequent time window.

9. The method of claim 1, further comprising:
ending the evaluating each of the plurality of SASs when a total duration of the plurality of time windows is equal to or greater than a predetermined simulation time period.

10. The method of claim 1, further comprising:
generating state trajectories for the power system state variables by combining the evaluations of two or more of the plurality of SASs from consecutive time windows.

11. The method of claim 1, wherein
deriving a plurality of SASs is performed during an offline stage prior to a contingency of the power system, and
evaluating each of the plurality of SASs is performed during an online stage following the contingency.

12. A system, comprising:
a power system; and
a computer system including a plurality of processors and memory storing instructions adapted to be executed by the plurality of processors to perform operations comprising:
evaluating a plurality of semi-analytic solutions (SASs) in parallel and consecutively over a plurality of time windows, wherein each SAS relates to at least one of a plurality of power system state variables; and
generating a control signal to control at least one element of the power system based on the evaluation of at least one of the SASs.

13. The system of claim 12, the operations further comprising:
adaptively varying durations of the plurality of time windows by comparing an indicator to a predetermined maximum threshold during each time window, wherein the indicator is a magnitude of one of last terms of each of the plurality of SASs.

14. The system of claim 12, the operations further comprising:
obtaining, from a numerical simulation of the power system, initial conditions for evaluating the plurality of SASs in a first time window of the time windows; and
for each subsequent time window, using ending states of at least one of the plurality of SASs in a preceding time window as initial conditions for evaluating the plurality of SASs in the subsequent time window.

15. The system of claim 12, the operations further comprising:
ending the evaluating each of the plurality of SASs when a total duration of the plurality of time windows is equal to or greater than a predetermined simulation time period.

16. The system of claim 12, the operations further comprising:
generating state trajectories for the power system state variables by combining the evaluations of two or more of the plurality of SASs from consecutive time windows.

17. The system of claim 12, wherein the plurality of SASs are derived by applying an Adomian decomposition method to a model of the power system and are stored in the memory.

18. The system of claim 12, wherein
each of the plurality of SASs is a summation of a plurality of terms,
each term includes a plurality of computing units, and
during the evaluating the plurality of SASs, the computing units are evaluated in parallel by the plurality of processors.
